(19) United States
(12) Patent Application Publication
(10) Pub. No.: US 2021/0389173 A1
(43) Pub. Date: Dec. 16, 2021

(54) WELLBORE STIMULATION CONTROL USING FIBER OPTIC DATA

(71) Applicant: Halliburton Energy Services, Inc., Houston, TX (US)

(72) Inventors: Mehdi Mazrooee, Double Oak, TX (US); Michael Linley Fripp, Carrollton, TX (US); Vladimir Nikolayevich Martysevich, Spring, TX (US)

(21) Appl. No.: 16/900,049

(22) Filed: Jun. 12, 2020

(51) Int. Cl. G01H 9/00; E21B 47/135; E21B 43/26

(52) U.S. Cl. CPC G01H 9/004; E21B 43/2607; E21B 47/135

(57) ABSTRACT

A well system includes a fiber-optic cable positionable downhole along a length of a wellbore. The well system further includes an opto-electrical interface to communicatively couple to the fiber-optic cable to monitor acoustic vibrations within the wellbore. Additionally, the well system includes a processing device and a memory device that includes instructions executable by the processing device to cause the processing device to perform operations. The operations include receiving data representing the acoustic vibrations from the opto-electrical interface. Further, the operations include identifying deficiencies of a hydraulic fracturing operation using the data representing the acoustic vibrations. Additionally, the operations include generating a modified fracturing plan using the deficiencies of the hydraulic fracturing operation.

### TECHNICAL FIELD

The present disclosure relates generally to wellbore stimulation control and, more particularly (although not necessarily exclusively), to wellbore stimulation control using wellbore acoustic data obtained from a distributed acoustic sensor.

### BACKGROUND

A well (e.g., an oil well or a gas well) may include a wellbore drilled through a subterranean formation. The subterranean formation may include a rock matrix permeated by oil or gas that is to be extracted using the well system. Hydraulic fracturing operations, or other stimulation techniques, performed on the subterranean formations may provide access to oil or gas that is located within the rock matrix. The hydraulic fracturing operations may be controlled based on stimulation plans generated prior to beginning the hydraulic fracturing operations.

A hydraulic fracturing operation may be difficult to monitor in real time. Accordingly, real-time adjustments to a stimulation plan during the hydraulic fracturing operation may be limited. Because real-time adjustments are limited, the implementation of the hydraulic fracturing operation may be less than optimal due to unplanned and unobserved diversions from the stimulation plan.

### BRIEF DESCRIPTION OF THE DRAWINGS

FIG. 1 is a schematic view of a well system with a distributed acoustic sensor for detecting acoustic signals according to one example of the present disclosure.

FIG. 2 is a schematic view of a control system for a hydraulic fracturing operation according to one example of the present disclosure.

FIG. 3 is flowchart of a process for controlling a hydraulic fracturing operation according to one example of the present disclosure.

FIG. 4 is a plot of acoustic energy within a wellbore during a hydraulic fracturing operation according to one example of the present disclosure.

FIG. 5 is a plot of acoustic signal frequency within a wellbore during a hydraulic fracturing operation according to one example of the present disclosure.

FIG. 6 is a block diagram of an example of a computing device according to one example of the present disclosure.

### DETAILED DESCRIPTION

Certain aspects and examples of the present disclosure relate to controlling hydraulic fracturing operations using acoustic data from a distributed acoustic sensor within a wellbore. The hydraulic fracturing operation may include pumping hydraulic fracturing fluid into the wellbore to generate fractures within a formation surrounding the wellbore. The fractures may enable enhanced access to hydrocarbons that are located within the formation. The distributed acoustic sensor my include a fiber-optic cable that is run into the wellbore and an opto-electrical interface that transmits light signals into the fiber-optic cable and receives reflected light signals from the fiber-optic cable. The reflected light signals may be partially scattered or otherwise disrupted by acoustic signals from within the wellbore. Acoustic data can be generated using the reflected light signals to provide information about the effectiveness of the hydraulic fracturing operation. This information may be used to control the hydraulic fracturing operation in real time.

Because the hydraulic fracturing operation is monitored and controlled in real time by the distributed acoustic sensor, the efficiency, effectiveness, and consistency of the hydraulic fracturing operation may be enhanced. For example, the hydraulic fracturing operation may be controlled based on current bottomhole conditions of a wellbore instead of hydraulic fracturing control relying solely on a well plan generated prior to beginning the hydraulic fracturing operation.

In an example, the distributed acoustic sensor may receive an optical signal from the wellbore that represents acoustic energy feedback at various locations along a fiber-optic cable of the distributed acoustic sensor. The acoustic energy feedback may be used to control a hydraulic fracturing operation or other wellbore stimulation operation. For example, the acoustic energy feedback information can be used to determine when to adjust fracturing fluid flow rate, proppant concentration, proppant type, fluid diverter, or any other hydraulic fracturing operation parameters. Further, additives can be controlled, such as fluid viscosity additives or friction reducers, using the acoustic energy feedback information. The acoustic energy feedback information can also be used to control timing of the hydraulic fracturing operation such as control of fluid diverters and operations at an end of a fracturing stage. Additionally, the acoustic energy feedback information can be used to accelerate a start time of a job, such as by controlling a fracture breakdown or an acid pad.

A method for performing a hydraulic fracturing operation within a wellbore may include injecting fracturing fluids into the wellbore according to a fracturing plan. The method may also include monitoring acoustic vibrations along a length of a fiber-optic cable of a distributed acoustic system within the wellbore. Further, the method may include automatically modifying the fracturing plan using the acoustic vibrations. Moreover, the method may include modifying parameters of the hydraulic fracturing operation, such as the fluid, additives, proppant, or flow rate, using the modified fracturing plan.

Illustrative examples are given to introduce the reader to the general subject matter discussed herein and are not intended to limit the scope of the disclosed concepts. The following sections describe various additional features and examples with reference to the drawings in which like numerals indicate like elements, and directional descriptions are used to describe the illustrative aspects, but, like the illustrative aspects, should not be used to limit the present disclosure.

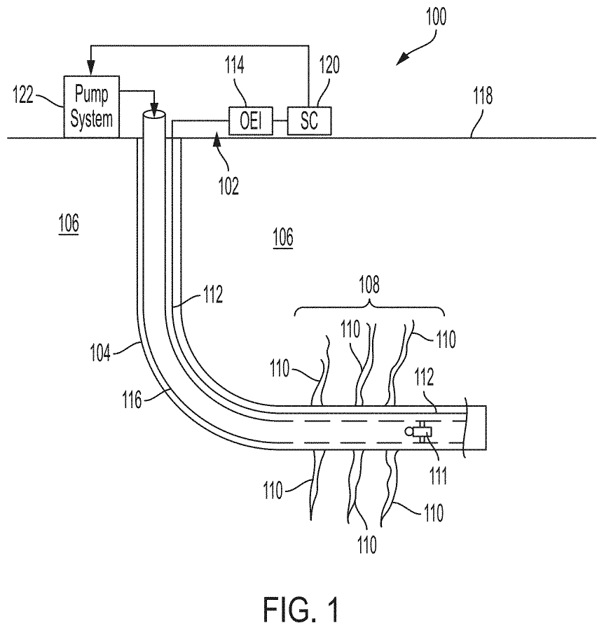

FIG. 1 is a schematic view of an example of a well system 100 with a distributed acoustic sensor 102 for detecting acoustic signals according to one example of the present disclosure. A wellbore 104 may be created by drilling into a formation 106 (e.g., a hydrocarbon bearing formation). To access hydrocarbons stored within the formation 106, hydraulic fracturing operations may be conducted after the wellbore 104 is drilled. A hydraulic fracturing operation generally includes pumping hydraulic fracturing fluid under pressure into a section 108 of the wellbore 104. The pressure of the hydraulic fracturing fluid creates fractures 110 within the formation 106 near a fracturing plug positioned within the wellbore 104. Through these fractures 110, hydrocarbons are able to flow into the wellbore 104 more freely.

The distributed acoustic sensor 102 may include a length of fiber-optic cable 112 that extends along a length of the wellbore 104. Distributed acoustic sensing that is performed by the distributed acoustic sensor 102 is a method of using nonlinearities in the fiber-optic cable 112 to detect acoustic vibrations. Information may be collected from the distributed acoustic sensor 102 during a hydraulic fracturing operation and used to determine adjustments to parameters of the hydraulic fracturing operation.

As illustrated, the fiber-optic cable 112 may be communicatively coupled to an opto-electrical interface 114. In operation, the fiber-optic cable 112 and the opto-electrical interface 114 may be used to perform distributed acoustic sensing operations within the wellbore 104. For example, the fiber-optic cable 112 and the opto-electrical interface 114 may both be part of the distributed acoustic sensor 102. In an example, the opto-electrical interface 114 may inject optical signals into the fiber-optic cable 112 and detect variations in a reflection signal received from the fiber-optic cable 112. The variations in the reflection signal may be due to Rayleigh scattering resulting from acoustic signals received along the fiber-optic cable 112. In one or more examples, the opto-electrical interface 114 may be an optical time domain reflectometer. Any other types of reflectometers may also be used. The distributed acoustic sensing operations within the wellbore 104 may provide a mechanism to determine locations and event magnitudes of acoustic events caused by the hydraulic fracturing operations that result in the fractures within the formation 106.

In an additional example, the opto-electrical interface 114 may also use Brillouin scattering or Raman scattering along the fiber-optic cable 112 during the distributed acoustic sensing operation. The Brillouin scattering may include a Stokes and an anti-Stokes component as light is shifted to higher frequency and to low frequency due to quantum interaction between light photons and acoustic phonons. The Raman scattering may occur as light interacts with molecular vibrations in the fiber-optic cable 112. Further, the Raman scattering may generate Stokes and anti-Stokes components. Both Brillouin and Raman scattering may include a much lower intensity than the Rayleigh scattering. Accordingly, more integration of the light pulses may be used to generate an accurate measurement of the acoustic energy within the wellbore. An absolute value or relative values between the Stokes scattering, the anti-Stokes scattering, and the Rayleigh scattering may be used.

The fiber-optic cable 112 may be attached to an outer surface of a casing 116 within the wellbore 104, suspended from a surface 118 of the wellbore 104 between the casing 116 and a wall of the wellbore 104 (e.g., within cement between the casing 116 and the wall of the wellbore 104), or positioned within the casing 116. The opto-electrical interface 114 may be positioned at the surface 118 of the well system 100. The opto-electrical interface 114 may detect acoustic events near the fiber-optic cable 112 within the wellbore 104 (e.g., vibration of the formation 106 resulting from seismic waves) that contribute to strain or displacement of the fiber-optic cable 112.

In one example, the opto-electrical interface 114 may include a computing device with a data acquisition system that can receive the acoustic data from the fiber-optic cable 112 and process the acoustic data using various analysis and visualization tools. The computing device of the opto-electrical interface 114 may include a processor and a non-transitory computer-readable medium that includes instructions that are executable by the processor to perform various operations described herein with regard to FIGS. 1-6.

The distributed acoustic sensor 102, which may include the fiber-optic cable 112 and the opto-electrical interface 114, is able to measure changes in strain along the fiber-optic cable 112 at a number of locations along a length of the fiber-optic cable 112. For example, the distributed acoustic sensor may measure changes in strain in 1 meter increments (i.e., 1 meter gauge lengths) along the length of the fiber-optic cable 112. Other section lengths of the fiber-optic cable 112 that are either larger or smaller than 1 meter are also contemplated, such as 1 centimeter to 10 meter lengths. The distributed acoustic sensor may measure the changes in strain along the fiber-optic cable 112 at a rate of 10 to 50,000 measurements per second. A resulting data stream of measured acoustic signals is used in a processing algorithm to determine features associated with the measured acoustic signals.

In an example, the opto-electrical interface 114 may provide acoustic data to a stimulation controller 120. The stimulation controller 120 may control a pump system 122 based on the acoustic data obtained by the distributed acoustic sensor 102 from the wellbore 104. As the opto-electrical interface 114 obtains the acoustic data from the wellbore 104, the stimulation controller 120 may control the pump system 122 to adjust a proppant concentration in a fracturing fluid, a pumping rate of the fracturing fluid, a fracturing fluid pressure, or any other hydraulic fracturing parameters that are adjustable to increase the hydraulic fracturing efficiency based on the acoustic data obtained from the wellbore 104.

While only a single fracturing stage is shown in FIG. 1, multiple fracturing stages may be monitored and controlled using the systems and techniques described herein. For example, several additional fracturing stages may be located further downhole from the fractures 110, and the fiber-optic cable 112 may extend into the wellbore 104 to provide monitoring in each of the additional stages.

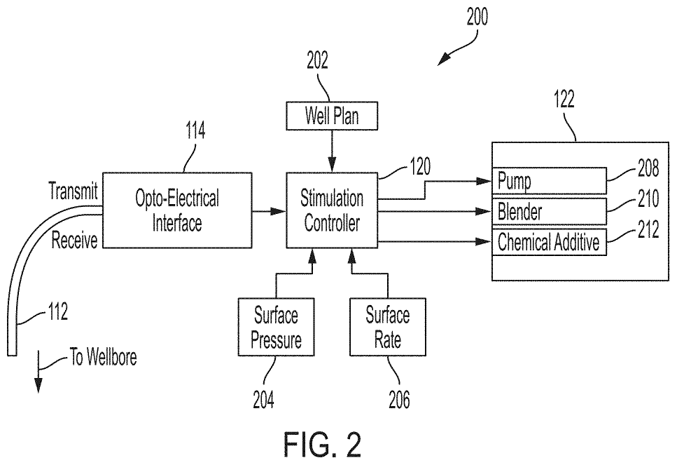

FIG. 2 is a schematic view of a control system 200 for a hydraulic fracturing operation according to one example of the present disclosure. As shown, the opto-electrical interface 114 may transmit light signals onto the fiber-optic cable 112 and receive reflected light signals from the fiber-optic cable 112. The reflected light signals may be partially scattered, may be partially frequency shifted, or may have varying arrival times due to acoustic signals within the wellbore 104. The partially scattered, reflected light signals may be analyzed by the opto-electrical interface 114 to generate acoustic data that is associated with the hydraulic fracturing operation that is performed on the wellbore 104. In some examples, the opto-electrical interface 114 may analyze the acoustic data prior to providing analyzed acoustic data to the stimulation controller 120. In other examples, the raw acoustic data may be provided to the stimulation controller 120 for further analysis. That is, the raw acoustic data may be analyzed by the stimulation controller 120 for information that is related to the control of the hydraulic fracturing operation.

The opto-electrical interface 114 may also provide temperature data to the stimulation controller 120 in addition to the acoustic data. For example, the fiber-optic cable 112 may also operate as a distributed temperature sensor, where temperatures along a length of the fiber-optic cable 112 can be observed. The changes to the sensed temperature may indicate changes in the flow of the fracturing fluid into the fractures 110. Accordingly, the stimulation controller 120 may use the temperature information as an additional input to adjust the parameters of the hydraulic fracturing operation. In some examples, the distributed temperature sensing may be used independently from the distributed acoustic sensing or together with the distributed acoustic sensing.

In an example, the stimulation controller 120 may be a perturbation-based controller. For example, if a parameter of the hydraulic fracturing operation changes, the distributed acoustic sensor 102 indicates how the change affects the hydraulic fracturing of the formation 106. Using this feedback, a determination can be made about whether the parameter change improved the hydraulic fracturing operation. If the perturbation did improved the hydraulic fracturing operation, then the stimulation controller 120 may continue in the direction of the perturbation. If the perturbation did not improve the performance, then the stimulation controller 120 may shift the adjusted parameter in the opposite direction from the previous adjustment. In other words, the stimulation controller 120 may adjust Bayesian priors based on downhole measurements from the distributed acoustic sensor 102.

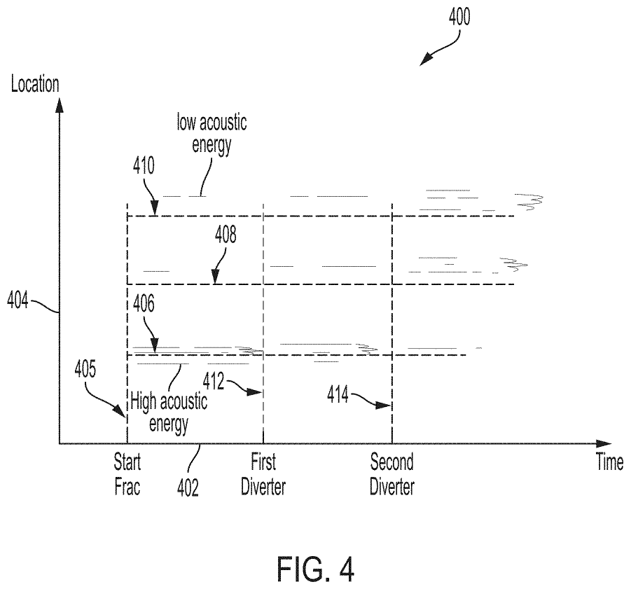

The stimulation controller 120 may also include analytical or machine learning models that can be used to interpret the fiber-optic measurements from the opto-electrical interface 114. The analytical or machine learning models may use the interpreted measurements to generate real-time drive signals that control parameters of the hydraulic fracturing operation. Additionally, the analytical or machine learning models may provide decisions for one-time events such as diversion drops, as discussed below with respect to FIG. 4, or job parameter changes.

The stimulation controller 120, in addition to receiving or accessing acoustic data for analysis or receiving pre-analyzed acoustic data, may also receive or otherwise access a well plan 202, a surface pressure indication 204, and a surface rate indication 206. The well plan 202 may provide a hydraulic fracturing parameters for a stimulation operation of the wellbore 104. In an example, the hydraulic fracturing parameters of the well plan 202 may include a pumping rate, a proppant concentration, a chemical additive concentration, a diverter agent, a frac ball, or any other hydraulic fracturing parameters. The well plan 202 may be used to determine an expected location for the fractures 110. Additionally, the well plan 202 may include a number of perforations in a cluster, a number of clusters, and a length and dimensions of the casing 116.

The surface pressure indication 204, which is also provided to the stimulation controller 120, may indicate a measured pressure within the wellbore 104, as measured near the surface 118 of the wellbore 104. Additionally, a surface rate indication 206 that is provided to the stimulation controller 120 may indicate a flow rate of the hydraulic fracturing fluid from a pump 208 of the pump system 122. The stimulation controller 120 may control a pump rate of the pump 208, a proppant concentration provided by a blender 210, and a chemical additive concentration provided by a chemical additive controller 212. The control of the features of the pump system 122 may be based on the acoustic data received from the opto-electrical interface 114, the well plan 202, the surface pressure indication 204, and the surface rate indication 206 of the pump 208.

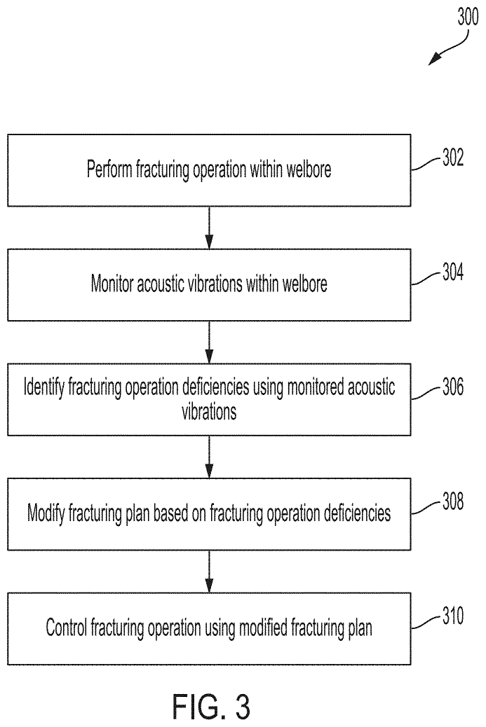

FIG. 3 is flowchart of a process 300 for controlling a hydraulic fracturing operation according to one example of the present disclosure. At block 302, the process 300 involves performing a hydraulic fracturing operation within the wellbore 104. In an example, the hydraulic fracturing operation involves pumping a fracturing fluid into the wellbore 104 to generate the fractures 110 in the formation 106. The hydraulic fracturing operation may be performed based on a well plan, which may be generated based on geological characteristics of the formation 106 surrounding the wellbore 104.

At block 304, the process 300 involves monitoring acoustic vibrations within the wellbore 104. The acoustic vibrations may be monitored using the distributed acoustic sensor 102. Monitoring the acoustic vibrations may enable detection of real-time information from within the wellbore 104 about the hydraulic fracturing operation. For example, the data generated from the acoustic vibrations may provide an indication of changes to a volume of fluid entering the fractures 110. The changes to the volume of fluid entering the fractures 110 may indicate which fractures 110 are actually receiving fluid and when a sandout of the fractures 110 will occur. The sandout may occur when the fractures 110 are no longer able to accept additional proppant from the fracturing fluid.

The distributed acoustic sensor 102 may monitor the acoustic vibrations within the wellbore 104 during a breakdown of the formation 106 that generates the fractures 110. During the breakdown, the hydraulic fracturing operation is seeking to create straight pathways from the wellbore 104 into the formation 106. The acoustic vibrations monitored by the distributed acoustic sensor 102 may show a flow rate of the fracturing fluid at different fractures 110 or clusters of the fractures 110. The stimulation controller 120 may adjust the hydraulic fracturing operation such that a clear indication of sufficient flow is provided at a sufficient number of the clusters of fractures 110. The feedback control may be used by the stimulation controller during the creation of the fracture and during placement of the proppant within the fracture.

At block 306, the process 300 involves identifying hydraulic fracturing operation deficiencies using the monitored acoustic vibrations. The hydraulic fracturing operation deficiencies may include any deviations in the hydraulic fracturing operation from a pre-determined fracturing plan. In an example, the acoustic energy at the fractures 110 may vary depending on the performance of the hydraulic fracturing operation. For example, the distributed acoustic sensor 102 may monitor acoustic frequencies at multiple clusters of the fractures 110. By monitoring the acoustic frequencies at multiple clusters, an observation can be made about whether each of the fractures 110 are receiving the same amount of fracturing fluid. The hydraulic fracturing operation can then be adjusted to account for one or more of the fractures 110 receiving too much or too little fracturing fluid, as discussed below with respect to FIG. 4.

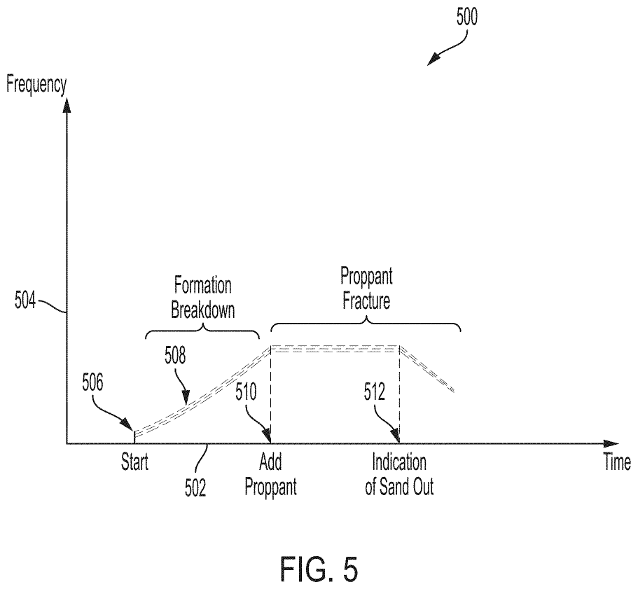

Monitoring the acoustic frequencies can include monitoring the amplitude of a measured acoustic signal at specific frequencies or specific frequency ranges, monitoring a relative amplitude of the measured acoustic signal at multiple frequencies or multiple frequency ranges, and monitoring a change in the amplitude of the measured acoustic signal at specific frequencies or frequency ranges. In some examples, the acoustic frequency of interest may be between 500 Hz and 10 kHz. In another example, the specific frequency ranges may be 100 Hz to 2000 Hz and from 5 kHz to 20 kHz. The acoustic frequencies represent an analog signal. In another example, the acoustic frequency may trigger different timing events in the hydraulic fracturing operation. For example, the application of proppant may be controlled based on an acoustic signal that indicates when the fractures 110 are no longer able to receive more proppant, as discussed below with respect to FIG. 5.

At block 308, the process 300 involves modifying a hydraulic fracturing plan, which may be a hydraulic fracturing operation portion of an overall well plan, based on the deficiencies of the hydraulic fracturing operation. For example, the hydraulic fracturing plan may call for specific hydraulic fracturing parameters, such as flow rates, diverter timings, proppant concentrations, viscosities of the fracturing fluid, or friction reducers. The acoustic information gathered from the distributed acoustic sensor 102 may be used by the stimulation controller 120 to adjust one or more of the hydraulic fracturing parameters.

In an example, the hydraulic fracturing plan may indicate a change to a flow rate of the fracturing fluid to achieve a proper perforation cluster efficiency or a uniform flow distribution between the fractures 110. The timing of the diverters may also be adjusted by the hydraulic fracturing plan. The diverters, which may be chemical or mechanical, can be injected into the wellbore 104 to encourage equal fracturing fluid flow into the different fractures 110 or the different clusters of fractures 110.

In another example, the hydraulic fracturing plan may be modified to adjust the proppant concentration of the fracturing fluid. During the hydraulic fracturing operation, a goal is to place a maximum volume of proppant within the fractures 110. Additionally, the hydraulic fracturing plan may be modified to adjust the viscosity of the fracturing fluid. The viscosity of the fracturing fluid may be adjusted by adding or removing viscosifier chemicals to or from the fracturing fluid prior to pumping the fracturing fluid into the wellbore 104. The fluid viscosity may help push the proppant further into the fractures 110 by making the fracturing fluid viscous enough to suspend the proppant within the fracturing fluid, as opposed to allowing the proppant to sink within the fracturing fluid. Moreover, the hydraulic fracturing plan may be modified to adjust the presence of friction reducers in the fracturing fluid. The friction reducers may allow more surface pressure to be used to push the fracturing fluid into the fractures 110.

Further, the acoustic measurements from the distributed acoustic sensor 102 may be used to adjust when the hydraulic fracturing plan can switch from an acid pad to water in the main treatment. For example, the acid pad is used to dissolve cement near the wellbore 104 to further expose the formation 106. As the cement is dissolved, there may be a greater flow area and a reduced acoustic emission. As the frequency of the acoustic signal changes due to the reduced acoustic emission, the stimulation controller 120 can detect that the fluid type pumped into the wellbore 104 can be changed. For example, the reduced acoustic emission may trigger a change to the well plan to begin adding proppant to the fracturing fluid.

At block 310, the fracturing operation may be controlled based on the modified fracturing plan. For example, the stimulation controller 120 may adjust parameters of the hydraulic fracturing operation to improve results of the hydraulic fracturing operation. The adjustable parameters may include changing the RPM, gears, and number of pumps to adjust surface pressure provided by the pump 208 to pump the hydraulic fracturing fluid into the wellbore 104. The adjustable parameters may also include changing a proppant concentration that is blended into the hydraulic fracturing fluid by the blender 210. Additionally, the adjustable parameters can include the chemical additives provided by the chemical additive controller 212, such as viscosifiers, friction reducers, acid breakers, particulate diverters, gel, or crosslinkers that are added to the hydraulic fracturing fluid. Any other adjustable hydraulic fracturing parameters capable of improving hydraulic fracturing efficiency may be also be adjusted by the stimulation controller 120 using the modified fracturing plan.

FIG. 4 is a plot 400 of acoustic energy within the wellbore 104 during a hydraulic fracturing operation according to one example of the present disclosure. An X-axis 402 of the plot 400 represents time, and a Y-axis 404 represents a location or depth of the acoustic energy within the wellbore 104. The acoustic energy may be measured by the distributed acoustic sensor 102. At point 405, the hydraulic fracturing operation begins and acoustic measurements at depths 406, 408, and 410 are observable. The depths 406, 408, and 410 may represent locations of the fractures 110 or clusters of the fractures 110 within the wellbore 104.

As illustrated at the point 405, the acoustic energy at the depth 406 is much greater than the acoustic energy at the depths 408 and 410. This may indicate that more fracturing fluid volume is going into the fractures 110 at the depth 406 than the fractures 110 at the depths 408 and 410. This information may be analyzed by the stimulation controller 120 such that the hydraulic fracturing operation can be adjusted.

For example, after a predetermined amount of fracturing fluid has entered the fractures 110 at the depth 406, the stimulation controller 120 may release a diverter into the wellbore 104 at a point 412. The diverter may be a mechanical object or a chemical that prevents or restricts the fracturing fluid from entering the fractures 110 at the depth 406. As illustrated, the acoustic energy at the depth 406 is reduced after release of the diverter, and the acoustic energy at the depths 408 and 410 is increased.

In an example, the stimulation controller 120 may determine that the acoustic energy at the depth 406 is still greater than the acoustic energy at the depths 408 and 410. Accordingly, at point 414, the stimulation controller 120 may release a second diverter into the wellbore 104. After the second diverter is released into the wellbore 104, the acoustic energy at the depth 406 is reduced such that the fracturing fluid is diverted toward the fractures 110 at the depths 408 and 410.

The timing of the diverter releases in the plot 400 may increase the efficiency of the hydraulic fracturing operation when compared to a hydraulic fracturing operation that relies on diverter timings from a pre-determined fracturing plan. The distributed acoustic sensor 102 may monitor acoustic energy within the wellbore to determine when to change parameters of the hydraulic fracturing operation.

FIG. 5 is a plot 500 of acoustic signal frequency within a wellbore during a hydraulic fracturing operation according to one example of the present disclosure. In an example, the stimulation controller 120 may use relative acoustic frequencies to make adjustments to the fracturing plan portion of the well plan. An X-axis 502 of the plot 500 represents time, and a Y-axis 504 of the plot 500 represents frequency of an acoustic signal measured by the distributed acoustic sensor 102 within the wellbore 104.

At point 506, the hydraulic fracturing operation begins. The frequency of acoustic energy 508 may increase as the formation 106 surrounding the wellbore 104 breaks down to generate the fractures 110. Once the frequency of the acoustic energy 508 reaches a pre-determined level at point 510, the stimulation controller 120 controls the blender 210 to add proppant to the fracturing fluid. As proppant is added to the fractures 110, the frequency of the acoustic energy 508 remains consistent while the flow rate of the fracturing fluid is constant.

When the proppant begins to make bridges within the fractures 110, at point 512 the frequency of the acoustic energy 508 begins to fall. The drop in frequency may indicate that sandout within the fractures 110 is imminent. That is, the drop in frequency may indicate that the fractures 110 are almost at a state where the proppant will no longer be accepted. The stimulation controller 120 may observe this change in frequency, and the stimulation controller 120 may control the pump 208 to reduce the flow rate of the fracturing fluid, the blender 210 to reduce the concentration of the proppant in the fracturing fluid, or a combination thereof. The stimulation controller 120 may control the pump 208 and the blender 210 based on a rate of the decrease in frequency of the acoustic energy 508 after the point 512 and based on an amount of proppant already placed in a fracturing zone.

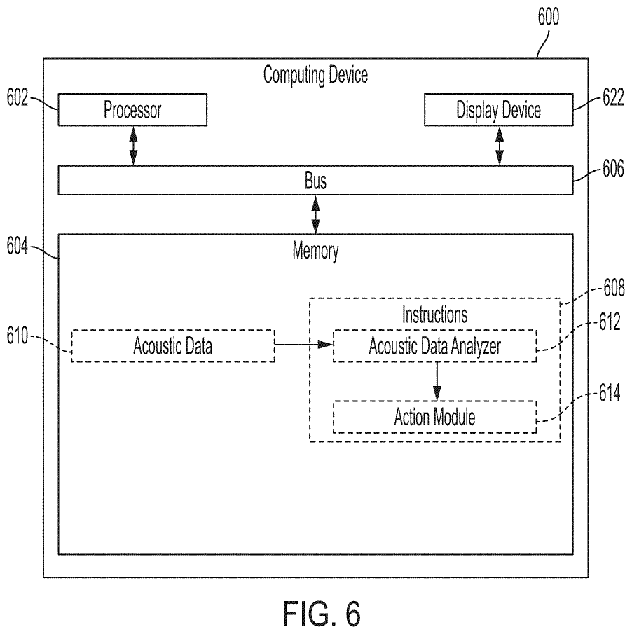

FIG. 6 is a block diagram of an example of a computing device 600 according to some aspects of the present disclosure. While FIG. 6 depicts the computing device 600 as including certain components, other examples may involve more, fewer, or different components than are shown in FIG. 6.

As shown, the computing device 600 includes a processor 602 communicatively coupled to a memory 604 by a bus 606. The processor 602 can include one processor or multiple processors. Non-limiting examples of the processor 602 include a Field-Programmable Gate Array (FPGA), an application-specific integrated circuit (ASIC), a microprocessor, or any combination of these. The processor 602 can execute instructions 608 stored in the memory 604 to perform operations. In some examples, the instructions 608 can include processor-specific instructions generated by a compiler or an interpreter from code written in any suitable computer-programming language, such as C, C++, C#, or Java.

The memory 604 can include one memory device or multiple memory devices. The memory 604 can be non-volatile and may include any type of memory device that retains stored information when powered off. Non-limiting examples of the memory 604 include electrically erasable and programmable read-only memory (EEPROM), flash memory, or any other type of non-volatile memory. At least some of the memory device includes a non-transitory computer-readable medium from which the processor 602 can read the instructions 608. A non-transitory computer-readable medium can include electronic, optical, magnetic, or other storage devices capable of providing the processor 602 with the instructions 608 or other program code. Non-limiting examples of a non-transitory computer-readable medium include magnetic disk(s), memory chip(s), ROM, random-access memory (RAM), an ASIC, a configured processor, optical storage, or any other medium from which a computer processor can read the instructions 608.

The memory 604 may include acoustic data 610 that is received from the distributed acoustic sensor 102 positioned within the wellbore 104. The instructions 608 may include a an acoustic data analyzer 612 that can receive the acoustic data 610 as input and provide an output indicating changes to implement in a hydraulic fracturing operation. For example, the computing device 600 can execute the acoustic data analyzer 612 based on the acoustic data 610 of the wellbore 104 to generate an output indicating new parameters of the hydraulic fracturing operation, such as a fracturing fluid pumping rate, a new blend of proppant within the fracturing fluid, a new chemical additive concentration for use in the fracturing fluid, or any combination thereof for the hydraulic fracturing operation.

The instructions 608 can also include an action module 614. The action module 614 can include executable program code for taking one or more actions based on the output of the acoustic data analyzer 612. For example, the computing device 600 can execute the action module 614 to control the hydraulic fracturing operation. Control of the hydraulic fracturing operation can be performed by the computing device 600 based on the new parameters of the hydraulic fracturing operation that are determined by the acoustic data analyzer 612. In some examples, a display device 622 of the computing device 600 may output a graphical user interface (GUI) that identifies the proposed changes to the parameters of the hydraulic fracturing operation. In an example, the proposed changes to the parameters that are displayed on the display device 622 may be accepted or rejected by an operator of the hydraulic fracturing operation.

In some aspects, systems and methods for controlling hydraulic fracturing operations are provided according to one or more of the following examples:

As used below, any reference to a series of examples is to be understood as a reference to each of those examples disjunctively (e.g., “Examples 1-4” is to be understood as “Examples 1, 2, 3, or 4”).

Example 1 is a well system comprising: a fiber-optic cable positionable downhole along a length of a wellbore; an opto-electrical interface to communicatively couple to the fiber-optic cable to monitor acoustic vibrations within the wellbore; a processing device; and a memory device that includes instructions executable by the processing device to cause the processing device to: receive data representing the acoustic vibrations from the opto-electrical interface; identify deficiencies of a hydraulic fracturing operation using the data representing the acoustic vibrations; and generating a modified fracturing plan using the deficiencies of the hydraulic fracturing operation.

Example 2 is the well system of example 1, further comprising: a pump system that is controllable using the modified fracturing plan to adjust parameters of the hydraulic fracturing operation.

Example 3 is the well system of example 2, wherein the pump system comprises a pump, a blender, a chemical additive controller, or a combination thereof that are controllable by the pump system to adjust the parameters of the hydraulic fracturing operation.

Example 4 is the well system of examples 1-3, wherein the deficiencies of the hydraulic fracturing operation comprise deviations of the hydraulic fracturing operation from a pre-determined fracturing plan.

Example 5 is the well system of examples 1-4, wherein the acoustic vibrations are monitored by the opto-electrical interface and the fiber-optic cable using Rayleigh scattering, Brillouin scattering, Raman scattering, or a combination thereof.

Example 6 is the well system of examples 1-5, wherein the instructions are further executable to cause the processing device to: access a pre-determined fracturing plan of the hydraulic fracturing operation; access an indication of a surface pressure at a surface of the wellbore; and access an indication of a flow rate of fracturing fluid entering the wellbore, wherein identifying the deficiencies of the hydraulic fracturing operation is performed using the pre-determined fracturing plan, the indication of the surface pressure, and the indication of the flow rate of the fracturing fluid.

Example 7 is the well system of examples 1-6, wherein the opto-electrical interface comprises an optical time domain reflectometer.

Example 8 is the well system of examples 1-7, wherein identifying the deficiencies of the hydraulic fracturing operation comprises: monitoring magnitudes of a set of acoustic energy readings at a plurality of fracturing locations within the wellbore; and detecting differences in the magnitudes of the set of acoustic energy readings at the plurality of fracturing locations, and wherein generating the modified fracturing plan comprises: modifying a release timing of a diverter into the wellbore upon detecting the differences in the magnitudes of the set of acoustic energy readings.

Example 9 is the well system of examples 1-8, wherein identifying the deficiencies of the hydraulic fracturing operation comprises: monitoring a frequency of acoustic energy at a fracturing location within the wellbore; and detecting a reduction in the frequency of the acoustic energy that indicates sandout of the fracturing location, and wherein generating the modified fracturing plan comprises: modifying a pumping rate of fracturing fluid into the wellbore upon detecting the sandout of the fracturing location.

Example 10 is a method comprising: performing a hydraulic fracturing operation within a wellbore; detecting acoustic energy within the wellbore using a distributed acoustic sensor; identifying deficiencies of the hydraulic fracturing operation using data representing the acoustic energy; generating a modified fracturing plan using the deficiencies of the hydraulic fracturing operation; and controlling the hydraulic fracturing operation using the modified fracturing plan.

Example 11 is the method of example 10, wherein identifying the deficiencies of the hydraulic fracturing operation comprises: monitoring magnitudes of a set of acoustic energy readings at a plurality of fracturing locations within the wellbore; and detecting differences in the magnitudes of the set of acoustic energy readings at the plurality of fracturing locations, and wherein generating the modified fracturing plan comprises: modifying a release timing of a diverter into the wellbore upon detecting the differences in the magnitudes of the set of acoustic energy readings.

Example 12 is the method of examples 10-11, wherein identifying the deficiencies of the hydraulic fracturing operation comprises: monitoring a frequency of the acoustic energy at a fracturing location within the wellbore; and detecting a reduction in the frequency of the acoustic energy that indicates sandout of the fracturing location, and wherein generating the modified fracturing plan comprises: modifying a pumping rate of fracturing fluid into the wellbore upon detecting the sandout of the fracturing location.

Example 13 is the method of examples 10-12, further comprising: accessing a pre-determined fracturing plan of the hydraulic fracturing operation; accessing an indication of a surface pressure at a surface of the wellbore; and accessing an indication of a flow rate of fracturing fluid entering the wellbore, wherein identifying the deficiencies of the hydraulic fracturing operation is performed using the pre-determined fracturing plan, the indication of the surface pressure, and the indication of the flow rate of the fracturing fluid.

Example 14 is the method of examples 10-13, wherein detecting the acoustic energy within the wellbore using the distributed acoustic sensor comprises detecting acoustic vibrations using Rayleigh scattering, Brillouin scattering, Raman scattering, or a combination thereof.

Example 15 is the method of examples 10-14, wherein the deficiencies of the hydraulic fracturing operation comprise deviations of the hydraulic fracturing operation from a pre-determined fracturing plan.

Example 16 is a non-transitory computer-readable medium having program code that is stored thereon, the program code executable by one or more processing devices to perform operations comprising: detecting acoustic energy during a hydraulic fracturing operation within a wellbore using a distributed acoustic sensor; identifying deficiencies of the hydraulic fracturing operation using data representing the acoustic energy; generating a modified fracturing plan using the deficiencies of the hydraulic fracturing operation; and controlling the hydraulic fracturing operation using the modified fracturing plan.

Example 17 is the non-transitory computer-readable medium of example 16, wherein the operation of identifying the deficiencies of the hydraulic fracturing operation comprises: monitoring magnitudes of a set of acoustic energy readings at a plurality of fracturing locations within the wellbore; and detecting differences in the magnitudes of the set of acoustic energy readings at the plurality of fracturing locations, and wherein generating the modified fracturing plan comprises: modifying a release timing of a diverter into the wellbore upon detecting the differences in the magnitudes of the set of acoustic energy readings.

Example 18 is the non-transitory computer-readable medium of examples 16-17, wherein the operation of identifying the deficiencies of the hydraulic fracturing operation comprises: monitoring a frequency of the acoustic energy at a fracturing location within the wellbore; and detecting a reduction in the frequency of the acoustic energy that indicates sandout of the fracturing location, and wherein generating the modified fracturing plan comprises: modifying a pumping rate of fracturing fluid into the wellbore upon detecting the sandout of the fracturing location.

Example 19 is the non-transitory computer-readable medium of examples 16-18, wherein detecting the acoustic energy within the wellbore using the distributed acoustic sensor comprises detecting acoustic vibrations using Rayleigh scattering, Brillouin scattering, Raman scattering, or a combination thereof.

Example 20 is the non-transitory computer-readable medium of examples 16-19, wherein the deficiencies of the hydraulic fracturing operation comprise deviations of the hydraulic fracturing operation from a pre-determined fracturing plan.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

What is claimed is:

1. A well system comprising:
a fiber-optic cable positionable downhole along a length of a wellbore;
an opto-electrical interface to communicatively couple to the fiber-optic cable to monitor acoustic vibrations within the wellbore;
a processing device; and
a memory device that includes instructions executable by the processing device to cause the processing device to:
receive data representing the acoustic vibrations from the opto-electrical interface;
identify deficiencies of a hydraulic fracturing operation using the data representing the acoustic vibrations; and
generating a modified fracturing plan using the deficiencies of the hydraulic fracturing operation.

2. The well system of claim 1, further comprising:
a pump system that is controllable using the modified fracturing plan to adjust parameters of the hydraulic fracturing operation.

3. The well system of claim 2, wherein the pump system comprises a pump, a blender, a chemical additive controller, or a combination thereof that are controllable by the pump system to adjust the parameters of the hydraulic fracturing operation.

4. The well system of claim 1, wherein the deficiencies of the hydraulic fracturing operation comprise deviations of the hydraulic fracturing operation from a pre-determined fracturing plan.

5. The well system of claim 1, wherein the acoustic vibrations are monitored by the opto-electrical interface and the fiber-optic cable using Rayleigh scattering, Brillouin scattering, Raman scattering, or a combination thereof.

6. The well system of claim 1, wherein the instructions are further executable to cause the processing device to:
access a pre-determined fracturing plan of the hydraulic fracturing operation;
access an indication of a surface pressure at a surface of the wellbore; and
access an indication of a flow rate of fracturing fluid entering the wellbore, wherein identifying the deficiencies of the hydraulic fracturing operation is performed using the pre-determined fracturing plan, the indication of the surface pressure, and the indication of the flow rate of the fracturing fluid.

7. The well system of claim 1, wherein the opto-electrical interface comprises an optical time domain reflectometer.

8. The well system of claim 1, wherein identifying the deficiencies of the hydraulic fracturing operation comprises:
monitoring magnitudes of a set of acoustic energy readings at a plurality of fracturing locations within the wellbore; and
detecting differences in the magnitudes of the set of acoustic energy readings at the plurality of fracturing locations, and wherein generating the modified fracturing plan comprises:
modifying a release timing of a diverter into the wellbore upon detecting the differences in the magnitudes of the set of acoustic energy readings.

9. The well system of claim 1, wherein identifying the deficiencies of the hydraulic fracturing operation comprises:
monitoring a frequency of acoustic energy at a fracturing location within the wellbore; and
detecting a reduction in the frequency of the acoustic energy that indicates sandout of the fracturing location, and wherein generating the modified fracturing plan comprises:
modifying a pumping rate of fracturing fluid into the wellbore upon detecting the sandout of the fracturing location.

10. A method comprising:
performing a hydraulic fracturing operation within a wellbore;
detecting acoustic energy within the wellbore using a distributed acoustic sensor;
identifying deficiencies of the hydraulic fracturing operation using data representing the acoustic energy;
generating a modified fracturing plan using the deficiencies of the hydraulic fracturing operation; and
controlling the hydraulic fracturing operation using the modified fracturing plan.

11. The method of claim 10, wherein identifying the deficiencies of the hydraulic fracturing operation comprises:
monitoring magnitudes of a set of acoustic energy readings at a plurality of fracturing locations within the wellbore; and
detecting differences in the magnitudes of the set of acoustic energy readings at the plurality of fracturing locations, and wherein generating the modified fracturing plan comprises:
modifying a release timing of a diverter into the wellbore upon detecting the differences in the magnitudes of the set of acoustic energy readings.

12. The method of claim 10, wherein identifying the deficiencies of the hydraulic fracturing operation comprises:
monitoring a frequency of the acoustic energy at a fracturing location within the wellbore; and
detecting a reduction in the frequency of the acoustic energy that indicates sandout of the fracturing location, and wherein generating the modified fracturing plan comprises:
modifying a pumping rate of fracturing fluid into the wellbore upon detecting the sandout of the fracturing location.

13. The method of claim 10, further comprising:
accessing a pre-determined fracturing plan of the hydraulic fracturing operation;
accessing an indication of a surface pressure at a surface of the wellbore; and
accessing an indication of a flow rate of fracturing fluid entering the wellbore, wherein identifying the deficiencies of the hydraulic fracturing operation is performed using the pre-determined fracturing plan, the indication of the surface pressure, and the indication of the flow rate of the fracturing fluid.

14. The method of claim 10, wherein detecting the acoustic energy within the wellbore using the distributed acoustic sensor comprises detecting acoustic vibrations using Rayleigh scattering, Brillouin scattering, Raman scattering, or a combination thereof.

15. The method of claim 10, wherein the deficiencies of the hydraulic fracturing operation comprise deviations of the hydraulic fracturing operation from a pre-determined fracturing plan.

16. A non-transitory computer-readable medium having program code that is stored thereon, the program code executable by one or more processing devices to perform operations comprising:
detecting acoustic energy during a hydraulic fracturing operation within a wellbore using a distributed acoustic sensor;
identifying deficiencies of the hydraulic fracturing operation using data representing the acoustic energy;
generating a modified fracturing plan using the deficiencies of the hydraulic fracturing operation; and
controlling the hydraulic fracturing operation using the modified fracturing plan.

17. The non-transitory computer-readable medium of claim 16, wherein the operation of identifying the deficiencies of the hydraulic fracturing operation comprises:
monitoring magnitudes of a set of acoustic energy readings at a plurality of fracturing locations within the wellbore; and
detecting differences in the magnitudes of the set of acoustic energy readings at the plurality of fracturing locations, and wherein generating the modified fracturing plan comprises:
modifying a release timing of a diverter into the wellbore upon detecting the differences in the magnitudes of the set of acoustic energy readings.

18. The non-transitory computer-readable medium of claim 16, wherein the operation of identifying the deficiencies of the hydraulic fracturing operation comprises:
monitoring a frequency of the acoustic energy at a fracturing location within the wellbore; and
detecting a reduction in the frequency of the acoustic energy that indicates sandout of the fracturing location, and wherein generating the modified fracturing plan comprises:
modifying a pumping rate of fracturing fluid into the wellbore upon detecting the sandout of the fracturing location.

19. The non-transitory computer-readable medium of claim 16, wherein detecting the acoustic energy within the wellbore using the distributed acoustic sensor comprises detecting acoustic vibrations using Rayleigh scattering, Brillouin scattering, Raman scattering, or a combination thereof.

20. The non-transitory computer-readable medium of claim 16, wherein the deficiencies of the hydraulic fracturing operation comprise deviations of the hydraulic fracturing operation from a pre-determined fracturing plan.
